(19) United States
(12) Patent Application Publication
(10) Pub. No.: US 2020/0401978 A1
(43) Pub. Date: Dec. 24, 2020

(54) INTELLIGENT RECOMMENDATION OF GOALS USING INGESTED DATABASE DATA

(71) Applicant: salesforce.com, inc., San Francisco, CA (US)

(72) Inventors: Aaron M. Popelka, San Francisco, CA (US); Luke A. Ball, Berkeley, CA (US); Joshua L. Sarver, Brownsburg, IN (US)

(21) Appl. No.: 16/447,519

(22) Filed: Jun. 20, 2019

(51) Int. Cl. G06Q 10/06; G06F 16/25; G06F 16/248; G06F 16/2457; G06F 3/0484

(52) U.S. Cl. CPC G06Q 10/06393; G06F 16/252; G06F 3/04847; G06F 16/2457; G06F 16/248

(57) ABSTRACT

Disclosed are some implementations of systems, apparatus, methods and computer program products for facilitating the intelligent recommendation and simulation of goals using ingested database data. A graphical user interface (GUI) is provided to facilitate configuration of a goal. A goal configuration indicates a goal defined by a goal definition, a target improvement in relation to the goal, and a target date. A determination is made as to whether the target improvement in relation to the goal can be achieved by the target date. A goal recommendation is presented according to a result of determining whether the target improvement in relation to the goal can be achieved by the target date. A goal recommendation can indicate a confidence with which the recommended goal can be achieved. After a goal is created, goal simulation can generate and provide a visual representation of predicted progression toward the goal over time. The visual representation can include one or more confidence levels that each indicates a confidence with which a corresponding level of progress toward the goal can be achieved.

### COPYRIGHT NOTICE

A portion of the disclosure of this patent document contains material, which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in its entirety and for all purposes.

### TECHNICAL FIELD

This patent document generally relates to goal generation and simulation implemented using ingested database data. More specifically, this patent document discloses techniques for recommending and simulating goals based upon a user-selected goal configuration.

### BACKGROUND

“Cloud computing” services provide shared network-based resources, applications, and information to computers and other devices upon request. In cloud computing environments, services can be provided by servers to users' computer systems via the Internet and wireless networks rather than installing software locally on users' computer systems. A user can interact with database systems, social networking systems, email systems, and instant messaging systems, by way of example, in a cloud computing environment.

Employees of an organization providing cloud computing services are often tasked with achieving a specific end result. To track their progress toward this end result, employees will often manually input data into a file. By periodically updating the file, the user can track their progress toward the desired end result. Unfortunately, this manual tracking process can be cumbersome and tedious. Moreover, in the event that the end result is unrealistic, this can lead to frustration and disappointment.

### BRIEF DESCRIPTION OF THE DRAWINGS

The included drawings are for illustrative purposes and serve only to provide examples of possible structures and operations for the disclosed systems, apparatus, methods and computer program products for recommending and simulating goals in an on-demand database environment. These drawings in no way limit any changes in form and detail that may be made by one skilled in the art without departing from the spirit and scope of the disclosed implementations.

FIG. 1 shows a system diagram of an example of a server system 100 for providing goal recommendation and simulation, in accordance with some implementations.

FIG. 2A shows an example of a user interface 200 in the form of a graphical user interface (GUI) presenting a main menu component, in accordance with some implementations.

FIG. 2B shows an example of a user interface 220 in the form of a GUI presenting a goal configuration component, in accordance with some implementations.

FIG. 2C shows an example of a user interface 250 in the form of a GUI presenting a goal recommendation responsive to user input submitted via a goal configuration component, in accordance with some implementations.

FIG. 2D shows an example of a user interface 270 in the form of a GUI presenting a goal configuration component that has been modified based upon the goal recommendation of FIG. 2C, in accordance with some implementations.

FIG. 3 shows an example of a user interface 300 in the form of a GUI presenting a badge that the user has earned upon creating a goal, in accordance with some implementations.

FIG. 4A shows an example user interface 400 in the form of a GUI supporting the simulation of progression toward a goal, in accordance with some implementations.

FIG. 4B shows an example user interface 450 in the form of a GUI presenting information related to the goal of FIG. 4A, in accordance with some implementations.

FIG. 4C shows an example user interface 470 in the form of a GUI presenting additional details related to the goal of FIG. 4A, in accordance with some implementations.

FIG. 4D shows an example user interface 480 in the form of a GUI presenting confidence levels related to the simulated progression toward the goal of FIG. 4A, in accordance with some implementations.

FIG. 5 shows an example of a method 500 for providing goal recommendations, in accordance with some implementations.

FIG. 6 shows an example of a method 600 for simulating goal progression, in accordance with some implementations.

FIG. 7 shows an example of a method 700 for simulating goal progression of a recommended goal, in accordance with some implementations.

FIG. 8A shows a block diagram of an example of an environment 10 in which an on-demand database service can be used in accordance with some implementations.

FIG. 8B shows a block diagram of an example of some implementations of elements of FIG. 8A and various possible interconnections between these elements.

FIG. 9A shows a system diagram of an example of architectural components of an on-demand database service environment 900, in accordance with some implementations.

FIG. 9B shows a system diagram further illustrating an example of architectural components of an on-demand database service environment, in accordance with some implementations.

### DETAILED DESCRIPTION

Examples of systems, apparatus, methods and computer program products according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Various implementations of the disclosed systems, apparatus, methods, and computer program products are configured for providing intelligent recommendation of goals. In some implementations, a goal recommendation may be provided within a goal recommendation component of a graphical user interface (GUI). The goal recommendation may be provided based upon an initial goal selected by a user. More particularly, where the initial goal is determined to be unrealistic or unlikely to be achieved, a goal recommendation that is more realistic and likely to be achieved is presented. The user may confirm a selection of the initial goal or, alternatively, may choose to pursue the recommended goal. The system may then store a goal configuration according to the user-selected goal. The goal recommendation component may be provided via a web-based application such as Salesforce's Lightning Console application, which is configured to support access to organizational data.

In accordance with various implementations, a goal may have an associated goal definition, a target improvement, and a target date. A goal definition may include a formula that identifies two or more fields of a database and indicates a relationship among the fields. A goal target (e.g., target improvement) may include a numerical value indicating a desired change in relation to the goal by the target date. For example, the target improvement may indicate a desired percentage increase or decrease in an amount defined by the goal definition (e.g., in relation to a current point in time).

In some implementations, a goal recommendation may indicate a different goal or a modification to the initial goal selected by the user. More particularly, a goal recommendation may indicate a recommended modification to the goal definition, a different goal having a different goal definition, a different target improvement including a second numerical value indicating a recommended target improvement (e.g., percentage increase or decrease) in relation to the goal, and/or a different target date.

In some implementations, a goal recommendation indicates a confidence level associated with the goal recommendation. The confidence level may indicate a likelihood that the recommended goal can be achieved by the target date.

In some implementations, the system tracks progression toward achieving a goal that has been configured. More particularly, the system may monitor progression toward achieving the goal based, at least in part, upon data stored in a database and the pertinent goal definition. The system may be configured to provide a visual representation of the progression. In addition, the system may be configured to provide notifications pertaining to the progression or lack thereof.

Various implementations of the disclosed systems, apparatus, methods, and computer program products are further configured for providing intelligent simulation of a goal. In some implementations, the goal simulation may be provided within a goal simulation component of a GUI. The goal simulation may be provided based upon a goal configured or selected by a user. The goal simulation component may be provided via a web-based application such as Salesforce's Lightning Console application.

In some implementations, a visual representation of a goal simulation is provided for display by a client device. The visual representation indicates a likelihood that the target improvement in relation to the goal can be achieved by the target date. The visual representation can include, but is not limited to, a graph, chart, spreadsheet, or other document.

In some implementations, the visual representation indicates one or more confidence levels in association with a goal simulation. Each of the confidence levels may include, for one or more points in time, a) a corresponding predicted improvement percentage or predicted goal amount in relation to the goal and b) a corresponding confidence indicator indicating a likelihood of achieving the predicted improvement percentage or predicted goal amount in relation to the goal by the corresponding point in time.

By way of illustration, Aaron is a marketing employee at an organization, Pyramid Construction, Inc. Aaron logs in to access a Console, which enables employees of the organization to access information maintained in data records. Aaron accesses a goal configuration component via the Console by selecting a corresponding option from a GUI. Upon accessing the goal configuration component, Aaron submits input indicating a set of goal configuration parameters that includes an identifier of a goal defined by a goal definition, a desired target improvement including a numerical value indicating a desired percentage increase in relation to the goal, and a target date. More particularly, Aaron indicates that the goal is a click-through-rate (CTR) increase, a desired target improvement of a 30 percent increase, and a target date of Dec. 25, 2019.

The system determines that the desired target improvement of a 30 percent increase is unrealistic. Instead, the system proposes a goal recommendation including an 18 percent increase. The system further indicates that the recommended goal can be achieved with a confidence of 85%. Aaron decides to accept the goal recommendation and the system then stores a goal configuration for the CTR, which includes an 18 percent increase and a target date of Dec. 25, 2019.

John clicks on a button in the user interface that requests that a simulation of the goal be generated via a goal simulation component. In response, the system provides a bar chart that indicates the predicted CTR at multiple points in time between the current date and the target date. John hovers over a segment of the representation that corresponds to Aug. 1, 2019 to view the system's calculation of the percentage improvement predicted to occur by that date, as well as the likelihood of achieving the percentage improvement and corresponding CTR represented for Aug. 1, 2019 in the bar chart. In response to John's interaction with the segment of the representation, the system provides three different confidence levels: a first confidence level indicates a predicted percentage improvement of 9.5 percent with a likelihood of 99 percent, a second confidence level indicates a predicted percentage improvement of 11.2 percent with a likelihood of 87 percent, and a third confidence level indicates a predicted percentage improvement of 13.8 percent with a likelihood of 75 percent.

In some but not all implementations, the disclosed methods, apparatus, systems, and computer-readable storage media may be configured or designed for use in a multi-tenant database environment or system. The term “multi-tenant database system” can refer to those systems in which various elements of hardware and software of a database system may be shared by one or more customers. For example, a given application server may simultaneously process requests for a great number of customers, and a given database table may store rows of data corresponding to data records for a potentially much greater number of customers.

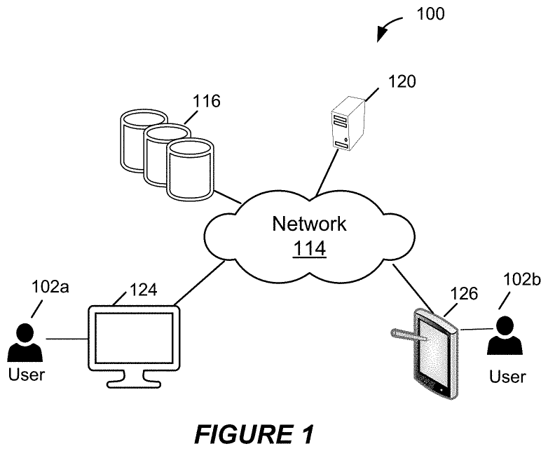

FIG. 1 shows a system diagram of an example of a server system 100 for providing goal recommendation and simulation, in accordance with some implementations. Server system 100 includes a variety of different hardware and/or software components that are in communication with each other. In the non-limiting example of FIG. 1 server system 100 includes at least one server 120, which is communicatively coupled to at least one content service database 116. Content service database 116 may be internal to server system 100 or external to server system 100. As shown in this example, server 120 may communicate with content service database 116 via a network 114. In accordance with various implementations, users 102a, 102b may access goal recommendation and/or goal simulation services provided by server 120 via their respective client computing devices 124, 126. Server 120 can access data stored in content service database 116 to provide goal recommendation and/or goal simulation services. Data can include data records such as customer relationship management (CRM) records. Example CRM records include, but are not limited to, cases, accounts, opportunities, leads, contacts, and/or activities. In addition, data accessed by server 120 can include, but is not limited to, records or data objects pertaining to goals, scheduled product releases, and/or scheduled campaigns. Content service database 116 can also store data records or objects pertaining to goal recommendations, goal simulations, and/or goal tracking.

In some implementations, users 102, 102b can access and/or update records or data objects pertaining to goals, goal definitions, goal recommendations, and/or goal simulations via their respective client computing devices 124, 126. In addition, in some implementations, users 102,102b can access information related to goals via their respective client computing devices 124, 126. Information related to a goal can include, for example, related goals, related campaigns, an identity of a user that generated the goal, a date that the goal was generated, information tracking progress toward achieving the goal, etc.

In some implementations, users 102a, 102b can access and/or update data records in content service database 116 via a GUI accessed via their respective client computing devices 124, 126. Updates to content service database 116 may include, for example, modifying data within a field of a data record, deleting a data record, or generating a new data record. Content service database 116 may include at least one relational database and/or at least one non-relational database.

Each non-relational database can allow for storage and retrieval of large sets of data. A non-relational database can be a database implemented in HBase or other non-relational database management system. This database can include one or more records for each of a plurality of enterprises (also referred to as organizations, or tenants.) In some implementations, the database can include one or more tables in which one or more enterprises have records. In some implementations, methods and applications are provided for the storage of data being captured in real-time.

Each relational database can allow for storage and retrieval of sets of data. In some implementations, a relational database can store and maintain records and data objects relating to CRM records. In some implementations, each relational database can be searched and queried in various ways by a user of system 100, providing for reports, graphs, data summaries, and other pieces of information.

Server 120 may communicate with other components of system 100. This communication may be facilitated through a combination of networks and interfaces. Server 120 may handle and process requests from client computing devices 124, 126. Likewise, server 120 may return responses to client computing devices 124, 126 after corresponding requests have been processed. Requests can include, for example, a request to configure a goal, a request to simulate a goal, or a data request pertaining to a goal or simulation. For example, in response to a data request, server 120 may retrieve data from one or more databases. It may combine some or all of the data from different databases, and send the processed data to a requesting client computing device.

Users 102a, 102b can include different users corresponding to a variety of roles and/or permissions. Client systems 124, 126 may each be a computing device capable of communicating via one or more data networks with a server. Examples of client devices include a desktop computer or portable electronic device such as a smartphone, a tablet, a laptop, a wearable device such as Google Glass®, another optical head-mounted display (OHMD) device, a smart watch, etc. Each of client devices 124, 126 may include at least one browser in which applications may be deployed.

In some implementations, a user may access goal recommendation and/or simulation services by logging in to a user account associated with a web site providing a web-based application via which goal recommendation and/or simulation services are provided. In some implementations, a user may have a single authorization identity. In other implementations, a user may have two or more different authorization identities. This can allow multiple modes of access to content or services.

An authorization service may be used to determine who can access goal recommendation services, goal simulation services, update content, generate content, or publish content. APIs can be used to access, modify, generate, or publish content, as well as to access goal recommendation or simulation services. In some implementations, access to content, services, or APIs can be restricted to an appropriate set of users.

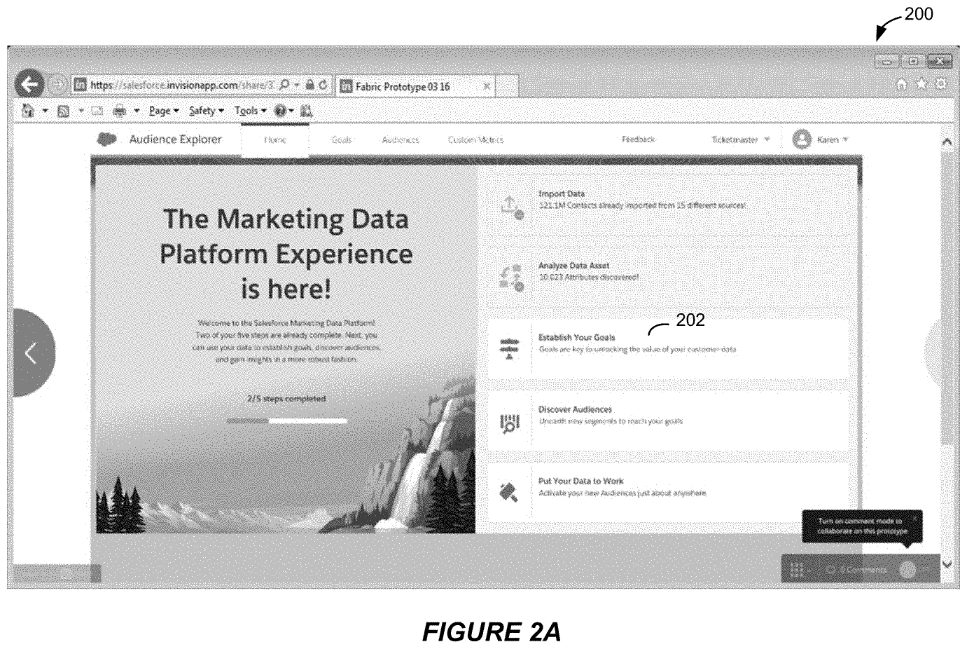

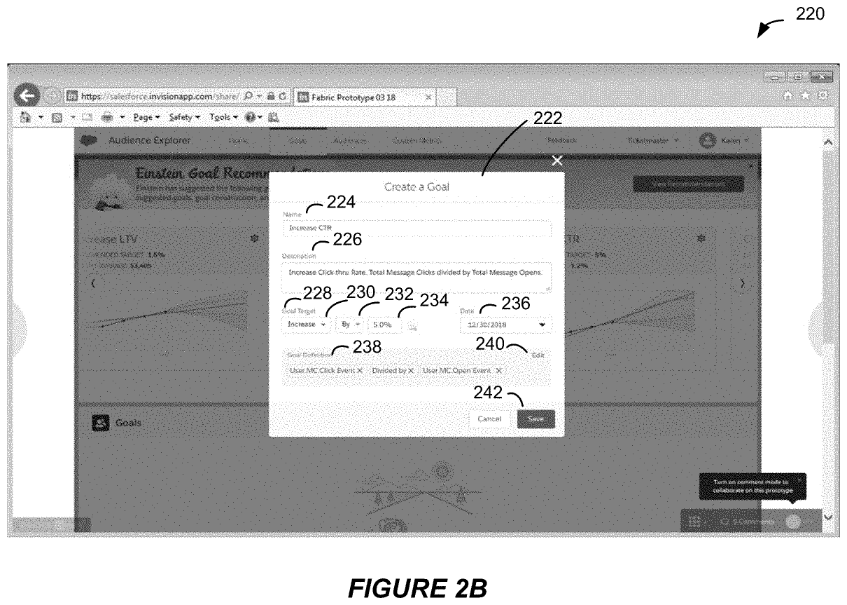

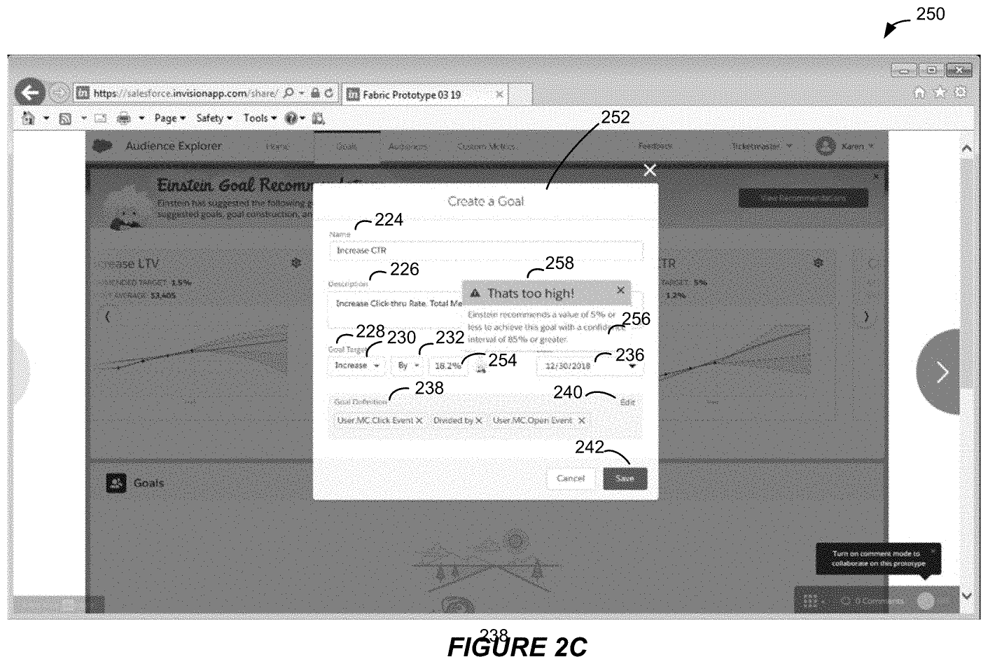

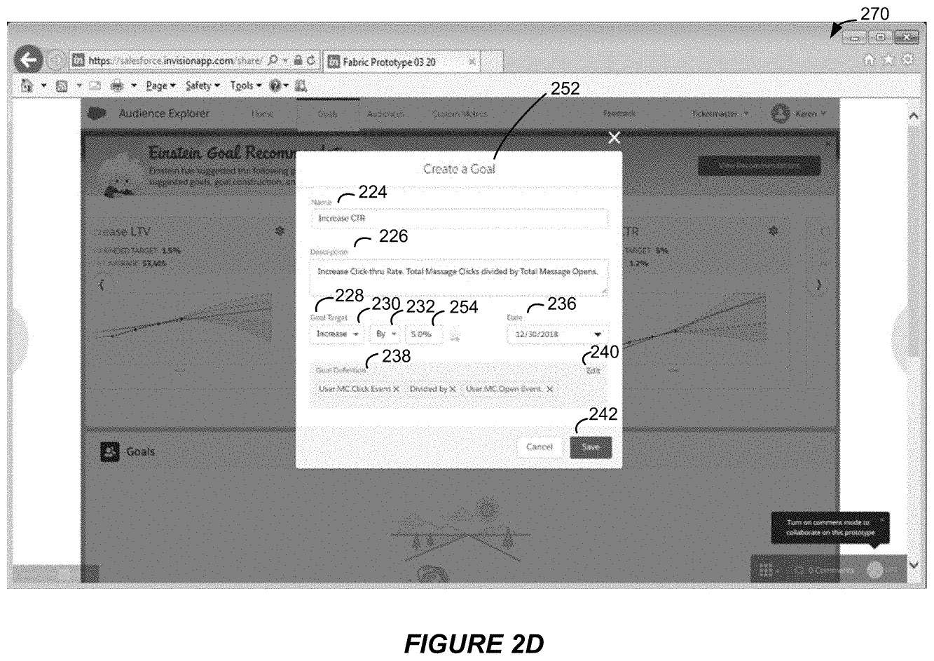

A user may log in to their user account to access web pages via which goal recommendation and/or simulation services are made available. FIG. 2A shows an example of a user interface 200 in the form of a graphical user interface (GUI) presenting a main menu component, in accordance with some implementations. User interface 200 can be provided via a web page of a web site such as a Home page, as shown in FIG. 2A. User interface 200 provides a user interface object 202 that represents goal recommendation services provided by the web site. By interacting with user interface object 202, the user indicates a request to access goal recommendation services. User interaction can include, but is not limited to, clicking on or hovering over user interface object 202. User interface object 202 may be presented as one of a plurality of selectable options, which may be made available via a menu, tabs, or other form of user interface. Thus, a user interface object can include a tab, button, menu option, input box, or other form of interface element configured to receive user input. Responsive to the selection of user interface object 202, the system may provide a further GUI such as that shown in FIG. 2B.

FIG. 2B shows an example of a user interface 220 in the form of a GUI presenting a goal configuration component 222, in accordance with some implementations. Goal confirmation component 222 is configured to obtain user input indicating parameter values corresponding to a set of goal configuration parameters. In this example, goal configuration parameters are represented by user interface objects 224-242. However, this example is merely illustrative, and goal configuration parameters may include a different number or type of parameters.

A user may specify or otherwise indicate a goal identifier that will be associated with the goal. More particularly, the user may specify or indicate a goal name 224 of the goal, which in this example pertains to a click through rate (CTR). In this example, the goal name is “Increase CTR.” The user may also provide a goal description 226.

In addition, the user may specify or indicate a target improvement, which may also be referred to as a goal target 228. Goal target 228 may indicate a direction 230 in which a change or improvement in a goal amount is desired over time. More particularly, direction 230 may indicate whether an increase or decrease in the goal amount is desired. Goal target 228 may also indicate a qualifier 232 in association with a numerical value 234 that indicates a target percentage by which the change in the goal amount is desired. In this example, direction 230 indicates that an increase in the goal amount from a current goal amount pertaining to goal 224 is desired, while qualifier 232 indicates that the change that is desired is “By” the indicated percentage “5.0%.” Other examples of qualifiers include, but are not limited to, “Greater Than” or “Less Than.” Although shown in this example as a percentage, goal target 228 may also indicate a final goal amount, such as a desired CTR.

The user may also specify or indicate a desired Target Date 236 by which target improvement is desired. In this example, Target Date 236 is 12/30/2019.

The user may also indicate or specify a Goal Definition 238 that defines the manner in which the goal amount corresponding to goal 224 is calculated. More particularly, Goal Definition 238 may identify or otherwise indicate one or more fields of records stored in Database 116. In addition, Goal Definition 238 may indicate a formula by which the goal amount is calculated using data pertaining to the indicated fields. More particularly, the formula can include one or more operators that indicate the relationship between or among the fields of Goal Definition 238. In this example, Goal Definition 238 includes operator “Divided by.”

In some implementations, Goal Definition 238 may be edited via goal configuration component 222. The user may choose to edit Goal Definition 238, which may be initiated by clicking on or otherwise interacting with a corresponding user interface object, shown as Edit button 240. Once the user has completed submitting input pertaining to the pertinent goal parameters, the user may decide to save the goal by interacting with Save user interface object 242.

After the user chooses to save the goal, the system may store a goal indicating the user-configured parameter values in a database. The goal can be stored such that it is associated with an entity such as the user, another user, a group, a department, or an organization. The entity may be indicated or specified by the user during the goal configuration. Once an association is generated, progress toward achieving the goal by the entity may be tracked. A result of the goal tracking may be stored, as well as provided and/or transmitted to individuals authorized to access goal tracking information.

In some implementations, the system may determine whether the goal can reasonably be achieved prior to storing the goal. If the system determines that the goal is reasonable, the system may proceed to store the goal. However, if the system determines that the goal that the user is attempting to save cannot reasonably be achieved, the system may provide a goal recommendation, as will be described in further detail below with reference to FIG. 2C.

FIG. 2C shows an example of a user interface 250 in the form of a GUI presenting a goal recommendation responsive to user input submitted via a goal configuration component, in accordance with some implementations. As shown in this example, the user has accessed goal configuration component 252 and has submitted a numerical value 254 that indicates a desired target percentage, 18.2%, by which the goal amount pertaining to goal 224, CTR, is to be increased over time from a current goal amount corresponding to goal 224. Responsive to user input indicating goal parameter values including numerical value 254 or indicating a request to save the goal at 242, the system may provide one or more goal recommendations, as appropriate.

In accordance with various implementations, the system determines whether the goal can be achieved. More particularly, the system may determine whether the indicated percentage change in the goal amount can be achieved by Target Date 236. If the system determines that the goal can be achieved (e.g., the indicated percentage change in relation to goal 224 can be achieved by Target Date 236), the system enables the user to proceed with saving the goal. However, if the system determines that the goal cannot be achieved, the system may provide a goal recommendation, as shown at 256. In addition, the system may notify the user via a pop-up window or other form of visual or audio notification that the user-specified goal cannot realistically be achieved, as shown at 258.

In accordance with various implementations, a goal recommendation 256 may include a recommended target improvement including or otherwise indicating one or more of: a) a second numerical value that is different from the value of the user-configured goal target (shown as target percentage 254), b) a recommended modification to the goal definition, or c) a recommended modification to the target date. For example, the second numerical value may indicate a recommended target percentage increase or decrease in relation to the goal. In some instances, a goal recommendation may pertain to a different goal (e.g., goal identifier) having a corresponding goal definition.

In some implementations, goal recommendation 256 further indicates a level of confidence associated with the goal recommendation. The level of confidence can indicate a likelihood that an improvement pertaining to goal 224 according to goal recommendation 256 can be achieved. More particularly, the level of confidence can include a numerical value that indicates a probability that an improvement, as indicated by goal recommendation 256, can be achieved.

In this example, the system has determined that the user-configured target percentage 254, 18.2%, is too high and cannot realistically be achieved by Target Date 236. Notification 258 informs the user that the target percentage 254 of 18.2% is too high. In addition, goal recommendation 256 recommends an alternate target percentage of 5% or less. Goal recommendation 256 also indicates that the recommended alternate target percentage can be achieved with a confidence level of 85% or greater.

FIG. 2D shows an example of a user interface 270 in the form of a GUI presenting a goal configuration component that has been modified based upon the goal recommendation of FIG. 2C, in accordance with some implementations. As shown in this example, the user has modified target percentage 254 to replace the previous the previous user-selected target percentage value, 18.2%, with the system-recommended target percentage of 5%. The user chooses to save the goal by interacting with user interface object 242 and the system stores goal 224 such that it includes or otherwise indicates the user-configured goal configuration parameter values.

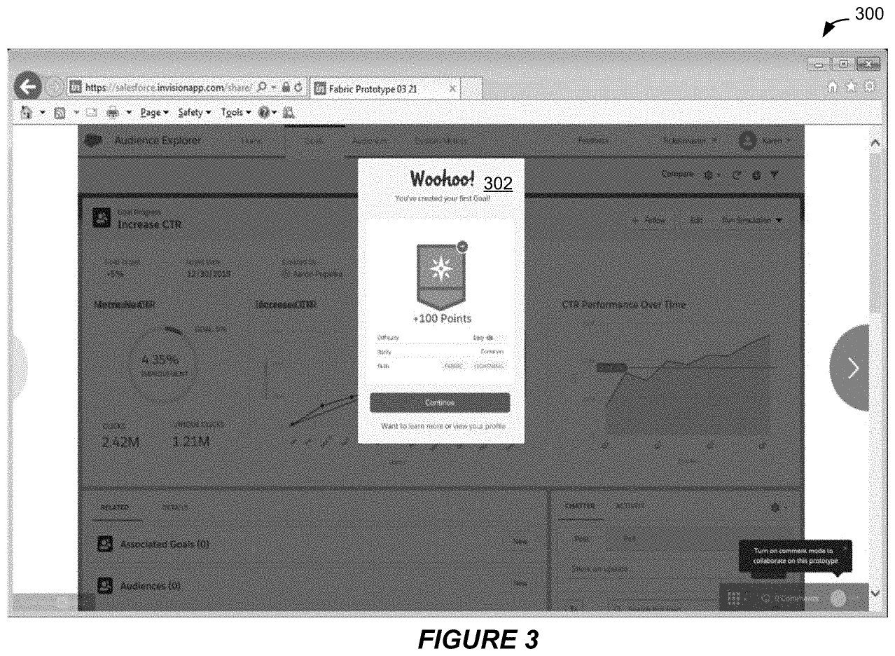

After the user has successfully created a goal by configuring goal configuration parameters, the user may receive a notification in association with the successful goal configuration. In some implementations, the user may receive a badge and/or points in relation to the goal configuration. FIG. 3 shows an example of a user interface 300 in the form of a GUI presenting a badge that the user has earned upon creating a goal, in accordance with some implementations. As shown in FIG. 3, badge 302 may indicate the number of points earned by the user. In this example, badge 302 indicates that the user has earned 100 points. In addition, badge 302 may indicate the level of difficulty, rarity, and/or skills associated with the completed goal configuration.

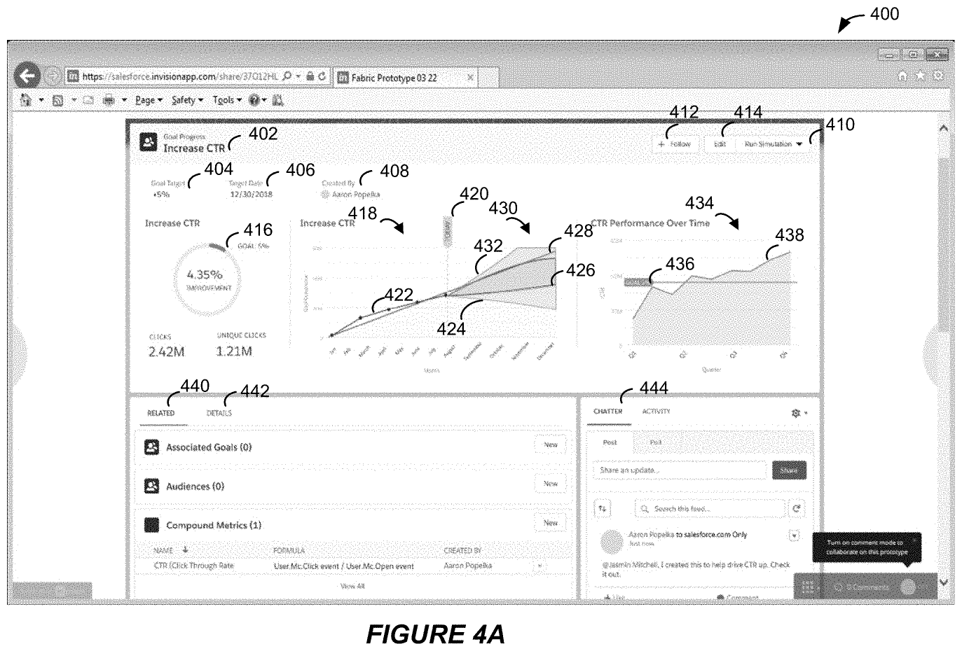

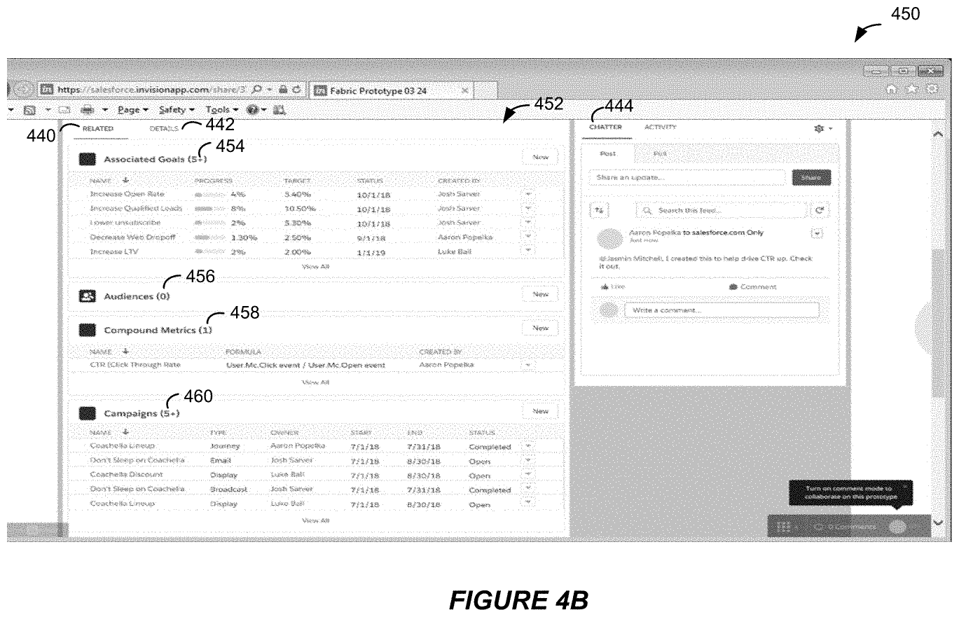

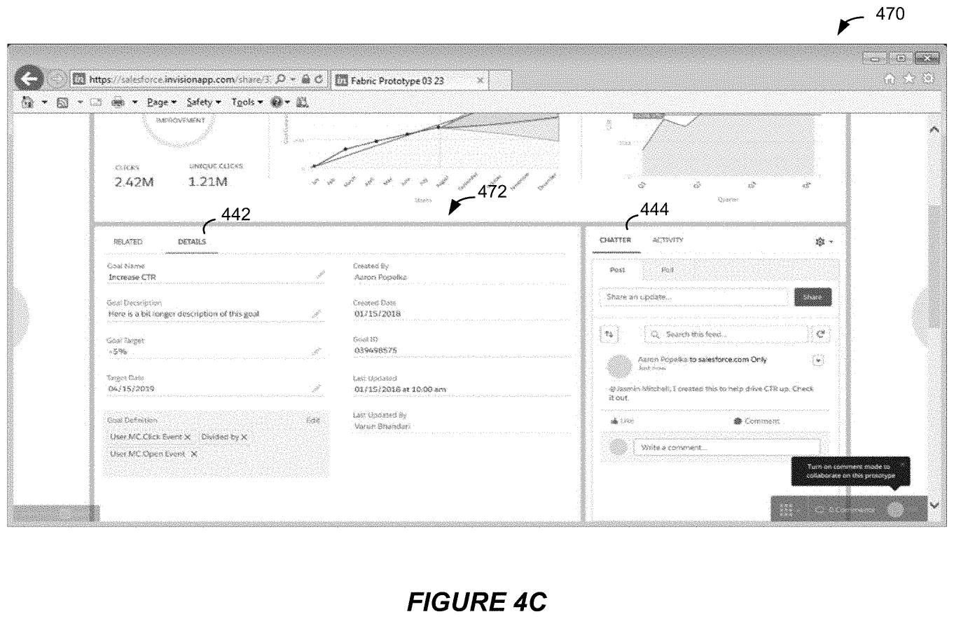

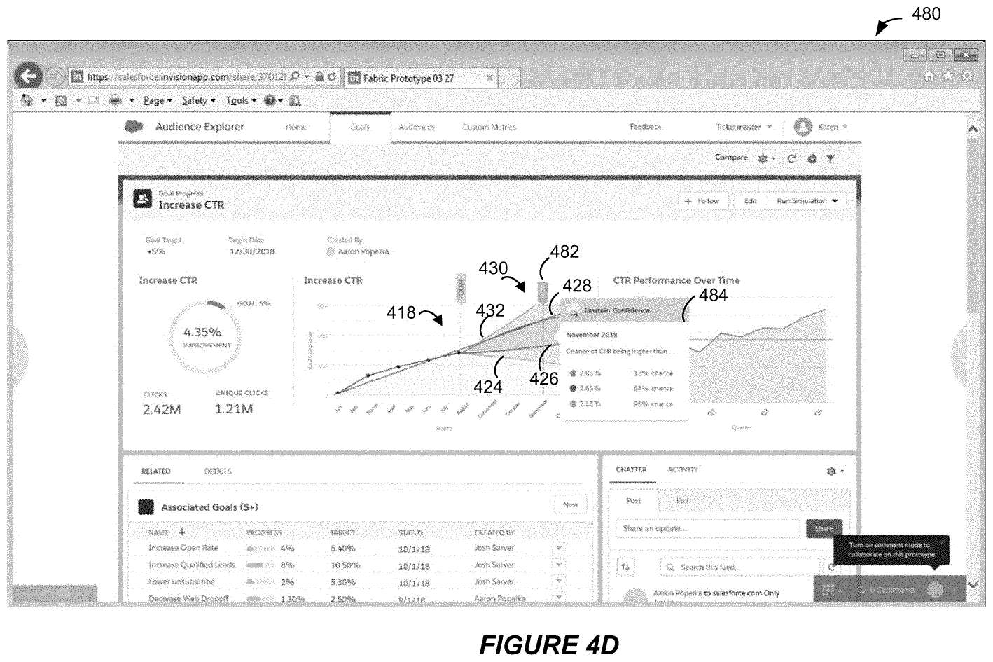

After a goal has been created, the user can run a simulation of progress toward achieving the goal over time. FIG. 4A shows an example user interface 400 in the form of a GUI supporting the simulation of progression toward a goal over time, in accordance with some implementations. For a given goal 402, user interface 400 can present the corresponding goal target 404 and target date 406. In this example, goal 402, Increase CTR, has a corresponding goal target 404 of 5% and a target date 406 of 12/30/2018. In addition, user interface 400 may identify the user that created goal 402, as shown at 408.

In some implementations, a simulation is run automatically. In other implementations, a simulation is run responsive to an indication of a user interaction with user interface object 410 of a goal simulation component of interface 400. One or more additional user interface objects may also be presented that provide additional functionality pertaining to goal 402 and/or corresponding simulations. In this example, a user may choose to follow goal 402 by interacting with user interface object 412. User interface 400 may also enable a user to edit goal 402 and/or corresponding simulation data that is presented by interacting with interface object 414.

User interface 400 can indicate the amount of improvement 416 in relation to goal target 404 that is predicted to be achieved by target date 406. In addition, additional data pertaining to goal 402 such as stored or predicted data that can be used to calculate a goal amount for goal 402 may be presented. For example, the number of clicks and/or the number of unique clicks that are predicted to be received by target date 406 may be presented.

A simulation may be generated based, at least in part, on data obtained from the pertinent fields of database records according to the goal definition corresponding to goal 402. In addition, the simulation may be generated based, at least in part, on additional data such as scheduled ad campaigns, scheduled product releases, and/or other goals. These other goals can include an additional goal that has been generated by the same user and/or pertains to the same entity (e.g., user, group, department, organization) as goal 402.

In some implementations, an additional goal used to generate a simulation is related to goal 402. More particularly, two or more goals can be stored such that they are linked to one another as related goals. Linking of goals can be user-initiated or automatic based upon one or more shared characteristics such as being created by the same user and/or pertaining to the same entity.

Running a simulation can generate simulation data that is presented via a visual representation 418. A visual representation can include any form of chart, graph, spreadsheet, or other document capable of presenting the simulation data or portion thereof. In this example, the x-axis represents progression over time, while the y-axis represents an amount of goal completion. More particularly, the amount of goal completion can include a goal amount represented by or calculated using the corresponding goal definition. Time can be represented by units such as months or quarters.

As shown in this example, representation 418 can indicate a current point in time 420, which can be represented as Today. Representation 418 can present calculated goal completion amounts 422 that have been determined using data collected for or during a previous period of time, where the previous period of time is prior to current point in time 420. As shown in this example, calculated goal completion amounts 422 can include multiple goal amounts, where each of the goal amounts corresponds to a different point in time (e.g., date) during the previous period of time. Therefore, representation 418 can indicate a progression of the calculated goal completion amounts 422 over the previous period of time.

Going forward in time from current point in time 420, representation 418 can represent simulation data that indicates a likelihood of achieving goal target 404 by target date 406. More particularly, simulation data can include multiple predicted goal completion amounts, where each of the predicted goal completion amounts corresponds to a different point in time during a subsequent period of time, where the subsequent period of time is after current point in time 420. Each of the predicted goal completion amounts can include a predicted goal completion amount that is likely to be achieved by the corresponding point in time. Therefore, representation 418 can indicate a progression of the predicted goal completion amounts over the subsequent period of time.

In some implementations, the simulation includes two or more different progression timelines. In this example, there are three different progression timelines, where each of the progression timelines represents a progression of multiple goal completion amounts over the subsequent period of time, where each of the goal completion amounts for a given timeline corresponds to a different point in time. More particularly, the progression timelines include a lowest progression toward goal target 404, a mid-level progression toward goal target 404, and a highest progression toward goal target 404, represented at 424, 426, and 428, respectively. Lowest progression can include multiple lowest predicted goal completion amounts, while highest progression can include multiple highest predicted goal completion amounts. Lowest predicted goal amounts can include the system's lowest predicted goal completion amounts that are likely to be achieved by the corresponding points in time, while the highest predicted goal amounts can include the system's highest predicted goal completion amounts that are likely to be achieved by the corresponding points in time.

Each of the different progression timelines can be generated using different sets of assumptions, rules, and/or further predictions. For example, highest predicted goal completion amounts can be generated based upon an assumption of the timely release of products according to product release schedules, while lowest predicted goal completion amounts can reflect an assumption that there will be a delay of the release of products according to the product release schedules. As another example, highest predicted goal completion amounts can be generated based upon an assumption that other related goals will be met, while lowest predicted goal completion amounts can reflect an assumption that other related goals will not be met.

In some implementations, representation 418 indicates one or more confidence levels 430, where each of the confidence levels indicates a level of confidence that a predicted goal completion amount or corresponding improvement percentage will be met (or exceeded) by the corresponding point in time. In this example, each of the different progression timelines 424, 426, 428 has an associated confidence level. More particularly, grey shaded area between 424 and 426 represents the confidence level corresponding to predicted goal completion amounts of lowest progression 424; blue shaded area between 426 and 428 represents the confidence level corresponding to predicted goal completion amounts of mid-level progression 426; and green shaded area between 428 and 432 represents the confidence level corresponding to predicted goal completion amounts of highest progression 428. For example, each of the confidence levels, or corresponding shaded areas, can represent a standard deviation from the corresponding progression.

In some instances, a representation 434 can represent a single progression over time. In this example, the x-axis represents progression over time, while the y-axis represents goal amounts (e.g., predicted goal amounts). While representation 418 represents units of time in months, representation 434 represents units of time in quarters. Therefore, the format in which simulation data is presented can vary according to implementation, configuration, or user-preference.

In representation 434, goal target 404 of 5% is represented as horizontal line 436. More particularly, horizontal line 436 represents goal amounts corresponding to a 5% increase from a goal amount corresponding to a current point in time or previously selected starting point (e.g., date). Progression of predicted goal amounts over time is represented at 438. A progression can represent simulation data over a period of time through an end date, which can include target date 406.

In some implementations, user interface 400 can further present additional information pertaining to goal simulation. In this example, this additional information includes related information 440 and details 442, which can be accessed via corresponding user interface objects such as tabs, as shown in FIG. 4A. Examples of related information 440 and details 442 will be described in further detail below with reference to FIGS. 2B and 2C, respectively.

In some implementations, user interface 400 includes a segment 444 that enables a user to post an update to a feed. For example, the user may post an update pertaining to a goal simulation. Those that receive the update can include those members of the user's group and/or those who are following the goal or goal simulation.

The user can access related information by selecting related information 440. FIG. 4B shows an example user interface 450 in the form of a GUI presenting information related to the goal of FIG. 4A, in accordance with some implementations. As shown in this example, portion 452 of user interface 400 can include related information 440. Related information can include, but is not limited to, information pertaining to associated goals 454 (e.g., related goals), audiences 456, compound metrics 458, and/or related campaigns 460. Associated goals 454 can include goals that impact or are likely to impact actual or predicted goal completion amounts. Related audiences 456 can indicate the audiences that have been identified from collected data that is pertinent to goal 402 and/or audiences that are predicted to contribute to the goal completion amount. Compound metrics 458 can include a goal definition corresponding to the pertinent goal 402. Campaigns 460 can include advertising campaigns that are related to goal 402, and are therefore likely to impact predicted goal completion amounts. In addition, related scheduled product releases (not shown) can be identified.

In addition, the user can access further details by selecting details 442. FIG. 4C shows an example user interface 470 in the form of a GUI presenting additional details related to the goal of FIG. 4A, in accordance with some implementations. As shown in this example, portion 472 of user interface 400 can include details 442 related to the goal. Details 442 can include, but are not limited to, a goal name, goal description, goal target, target date, and/or goal definition. In addition, details 442 can include an identity of the creator of the goal, the date that the goal was created, a goal identifier, a date that the goal was last updated, and/or an identity of the individual who last updated the goal.

The user may wish to access further information indicating the likelihood that the simulated progression is accurate. FIG. 4D shows an example user interface 480 in the form of a GUI presenting confidence levels related to the simulated progression toward the goal of FIG. 4A, in accordance with some implementations. As described above, three different confidence levels 430 are represented in FIG. 4D as corresponding shaded areas pertaining to respective progression timelines 424, 426, 428. In some implementations, additional details pertaining to confidence levels 430 may be provided for display adjacent to or in close proximity to confidence levels 430. In other implementations, the user may interact with a portion of representation 418 to view additional details pertaining to confidence levels 430.

For example, a user may interact with confidence levels 430 by hovering over or clicking a portion of representation 418 that is adjacent to or within confidence levels 430. More particularly, the user may interact with a portion of representation 418 that falls within the desired date or timeframe which may be indicated, for example, by the x-axis. In this example, the user has interacted with a portion of confidence levels 430 that corresponds to November, 2018, as shown at 482. In response, the system may provide a user interface object 484 that includes additional details pertaining to confidence levels 430 for the desired date/timeframe. For example, user interface object 484 can include a pop-up window.

As shown in FIG. 4D, user interface object 484 indicates, for each confidence level, the likelihood that a predicted goal completion amount or corresponding improvement percentage will be met (or exceeded) by the corresponding point in time. The likelihood that a predicted goal completion amount or corresponding improvement percentage will be met may be ascertained from information represented by confidence levels 430. Predicted goal completion amounts for November 2018 are represented in FIG. 4D by the intersection of line 482 with progression timelines 424, 426, 428. Since the user has selected November 2018, user interface object 484 indicates, for each confidence level, the likelihood that a corresponding predicted goal completion amount or improvement percentage will be met or exceeded by November 2018. More particularly, for the lowest progression timeline 424, the confidence level of meeting or exceeding the improvement percentage 2.15% by November 2018 is 95%; for the mid-level progression timeline 426, the confidence level of meeting or exceeding the improvement percentage 2.65% by November 2018 is 65%; for the highest level progression timeline 428, the confidence level of meeting or exceeding the improvement percentage 2.85% by November 2018 is 13%.

Based upon the simulation, the user may choose to proceed with the goal, delete the goal, or update the goal. For example, as shown in FIG. 4D, the goal target is 5%. However, according to the goal simulation, the chance of achieving an improvement of 2.85% by November 2018 is only 13%. Therefore, the user may choose to reduce the goal target to 3% or add another goal that would positively impact the goal of increasing the CTR.

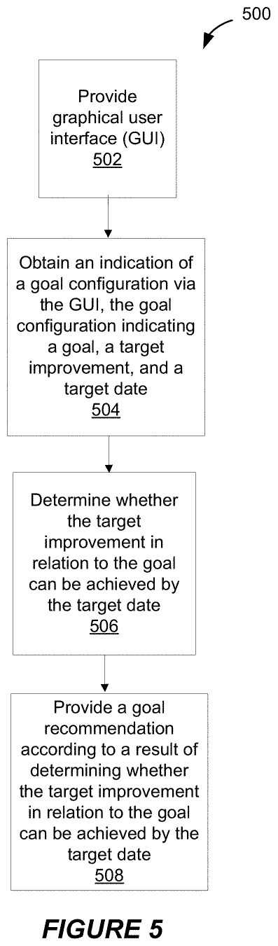

FIG. 5 shows an example of a method 500 for providing goal recommendations, in accordance with some implementations. As described above with reference to FIG. 2B, a graphical user interface (GUI) may be provided at 502 for display by a client device. The GUI can include at least one user interface object having one or more user interface elements configured to obtain user input in relation to configuration of a goal. User interface elements can include, but are not limited to, a menu, buttons, an input text box, and/or user-selectable options corresponding to one or more goal parameters.

The system can obtain, via the GUI, an indication of a goal configuration at 504. In some implementations, the goal configuration may include or otherwise indicate a goal defined by a goal definition, a target improvement in relation to the goal, and a target date. For example, the target improvement can include a numerical value indicating a target percentage increase or decrease in relation to the goal by the target date. The goal definition can include a formula identifying two or more database fields corresponding to database records of at least one data source, as well as one or more operands that indicate a relationship among the database fields.

Responsive to obtaining the indication of the goal configuration, the system may determine at 506 whether the target improvement in relation to the goal can be achieved by the target date. For example, the system may apply the goal definition to predict goal performance over time based, at least in part, on previously stored record data pertaining to the database fields identified within the formula. The system may further apply additional information such as that pertaining to related goals, scheduled product releases, and/or scheduled advertising campaigns to predict goal performance over time. For example, the additional information can include one or more dates pertaining to scheduled product releases or advertising campaigns, data indicating whether scheduled product releases or advertisement campaigns have occurred, and/or data indicating whether related goals have been met.

The system may determine the likelihood that the goal can be achieved by the target date. In some implementations, the system may compare the likelihood to a pre-defined threshold. For example, the system may determine that the likelihood that the goal can be achieved by the target date is 55%, while the threshold is 85%. Since the determined likelihood does not meet or exceed the threshold, the system may determine that the goal cannot be achieved by the target date.

In some implementations, the system determines whether the goal can be achieved by the target date based, at least in part, on data obtained from database records. More particularly, the system may obtain data from the data source according to the pertinent goal definition. Simulation data may then be generated based, at least in part, on the obtained data and the goal configuration. For example, the simulation data may represent predicted future performance in relation to the goal over a period of time (e.g., up to or through the target date). The simulation data may be generated according to the target date by extrapolating the obtained data over time. Alternatively, the simulation data may be generated using the obtained data, as well as additional information, as described herein. The system may then determine whether the target improvement in relation to the goal can be achieved by the target date based, at least in part, on the simulation data. For example, the system may determine the likelihood that the goal can be achieved by the target date based, at least in part, on the simulation data.

The system may provide a goal recommendation for display by the client device at 508 according to a result of determining whether the target improvement in relation to the goal can be achieved by the target date. More particularly, the system may provide a goal recommendation in the event that the system determines that the target improvement in relation to the goal cannot be achieved by the target date. The goal recommendation can include at least one of: a) a recommended target improvement, b) a recommended modification to the goal definition, or c) a recommended modification to the target date. The recommended target improvement can include a second numerical value, which may indicate a recommended target goal amount or a recommended target percentage increase or decrease in relation to the goal. For example, where the system enters a goal target of 5%, the system may recommend a target improvement of 4%.

The goal recommendation may be ascertained based, at least in part, on the simulation data. For example, the simulation data may indicate that a lower, alternate percentage improvement can be achieved by the target date. As another example, the simulation data may indicate that the desired percentage improvement can be achieved by a later target date.

In some implementations, the simulation data may indicate a confidence level with which a potential goal recommendation (e.g., alternate percentage improvement) can be achieved by the target date. The system may provide a goal recommendation if the corresponding confidence level exceeds a pre-defined threshold. For example, the system may recommend the lower, alternate percentage improvement if the confidence level exceeds a pre-defined threshold of 80%.

In some implementations, the goal recommendation that is provided for display by the client device can indicate a level of confidence associated with the goal recommendation. More particularly, the level of confidence may indicate a likelihood that an improvement according to the goal recommendation can be achieved. For example, the system may indicate that the goal recommendation of a 4% increase in the CTR by December 2018 has a confidence level of 85% or greater.

The user may choose to proceed with his or her initial goal configuration, choose the system-provided recommended goal configuration, or choose to modify either the initial goal configuration or system-provided recommended goal configuration. The system may obtain an indication of user input in relation to the goal recommendation. In response to the user input, the system may store or update a particular goal configuration that indicates values corresponding to the goal configuration parameters according to the user-selected goal configuration. The particular goal configuration may indicate a particular numerical value representing a particular target improvement in relation to the goal and indicate a particular target date. As set forth above, the particular target improvement can indicate a desired percentage change or a final goal amount.

In some implementations, the user may configure a goal as a personal goal. Alternatively, the user may configure a goal for another entity, such as another user, a group, a department, or an organization. Therefore, a goal may be stored in association with an entity to which the goal is to be applied.

In some implementations, the system may track the progression toward the particular target improvement in relation to the goal. More particularly, the system may obtain data from a database according to the goal definition. The system may then provide a visual representation or notification indicating performance of the goal up to a current date.

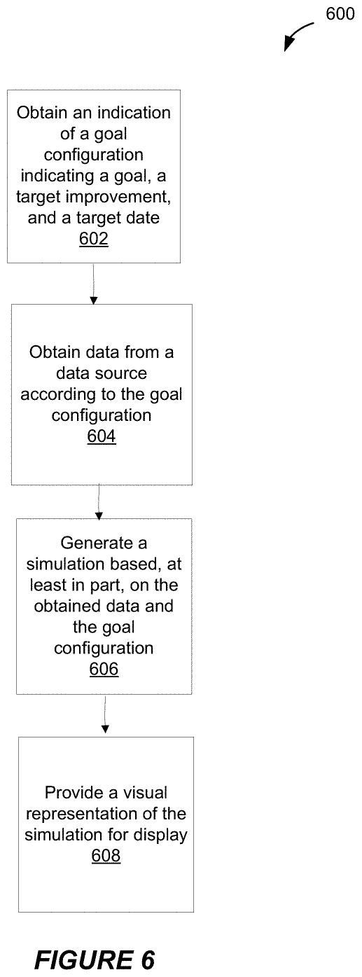

In some implementations, a simulation of performance of the saved goal may be generated and a visual representation of the simulation may be provided for display via a client device. Generation of a simulation will be described in further detail below with reference to FIG. 6.

After a goal is created (e.g., configured), progression toward the goal over time may be simulated. FIG. 6 shows an example of a method 600 for simulating goal progression, in accordance with some implementations. An indication of a goal configuration may be obtained at 602. As described above, the goal configuration may be obtained via a GUI. In addition, after a goal has been saved, the goal configuration may be retrieved from memory. The goal configuration may indicate a goal defined by a goal definition, a target improvement in relation to the goal, and a target date. The target improvement can include a numerical value indicating a target percentage increase or decrease in relation to the goal by the target date. Alternatively, the target improvement may include a specific goal amount. The goal definition can include a formula, as described above.

The system may obtain data from the data source according to the goal configuration at 604. The data can include record data from one or more database records of the data source.

The system may generate a simulation based, at least in part, on the obtained data and the goal configuration at 606, where the simulation represents predicted future performance in relation to the goal over a period of time (e.g., up to or including the target date). The simulation can include simulation data that is generated via extrapolation of the obtained data. Alternatively, the simulation data may be generated via a more complex process.

In some implementations, a simulation may be generated further based, at least in part, on additional information. This additional information can include rules, historical trends or data patterns over time, data pertaining to related or other goals, data pertaining to scheduled ad campaigns, and/or data pertaining to scheduled product releases. Historical trends or patterns identified by the system can indicate, for example, an increase or decrease in the calculated goal amount on a periodic basis, such as weekly, monthly, or quarterly. For example, CTR may historically decrease during the winter quarter but increase during the summer. In some implementations, weights may be applied to weigh the contributions of different types of data during the generation of simulation data. For example, a computer-generated model may be updated over time to refine the manner in which simulations are generated. A computer-generated model may be associated with a specific goal or category of goals.

The system may then provide, for display by the client device, a visual representation of the simulation at 608. More particularly, the visual representation may be configured to provide an indication of a likelihood of achieving the target improvement in relation to the goal by the target date. The visual representation may be static or dynamic.

In accordance with various implementations, the visual representation is configured to provide an indication of a likelihood of achieving a particular improvement amount by a particular point in time, where the particular improvement amount is less than or equal to the target improvement. The particular improvement amount may include a percentage increase or decrease. In addition, the particular point in time may be less than or equal to the target date. For example, where the goal target indicates that a target improvement is 5% by a target date of December 2018, the visual representation may indicate a 95% likelihood of achieving a 3.5% improvement by August 2018.

The system may provide one or more progression timelines, where each of the progression timelines represents a progression of multiple predicted goal completion amounts or predicted improvement percentages over a period of time, where each of the predicted goal completion amounts or predicted improvement percentages for a given timeline corresponds to a different point in time. In some implementations, two or more sets of rules or assumptions may be applied to generate two or more corresponding progression timelines.

In some implementations, the system provides one or more sets of confidence levels for display by a client device. Each of the sets of confidence levels can include one or more confidence levels that each corresponds to a corresponding level of progress or progression timeline. A level of progress can include a predicted goal amount or predicted improvement percentage toward the goal by a particular point in time.

In some implementations, each of the confidence levels indicates, for one or more points in time, a) a corresponding predicted improvement percentage or predicted goal amount in relation to the goal and b) a corresponding confidence indicator indicating a likelihood of achieving the predicted improvement percentage or predicted goal amount in relation to the goal by the corresponding point in time. The predicted improvement percentage or predicted goal amount may be less than or equal to the target goal amount. For example, where the user-specified goal target is 5% by December 2018, three different confidence levels can correspond to goal progress of 3.2%, 3.8%, and 4% by November 2018, where the confidence levels include 90%, 82%, and 71%, respectively.

A confidence level may be represented in the visual representation of the simulation via a graphical representation such as a shaded region adjacent to a corresponding progression timeline. In some implementations, a confidence level represents a standard deviation from the corresponding progression timeline. A confidence indicator for the confidence level may be rendered adjacent to or in close proximity to the graphical representation of the confidence level. A confidence level or corresponding confidence indicator may correspond to a particular point in time indicated in the visual representation. For example, a confidence indicator may indicate that the likelihood of achieving a predicted improvement percentage of 3.2% by a date of Oct. 1, 2018 is 85%, where the x-axis of the representation represents a time period of Jan. 1, 2018 through Dec. 1, 2018. Information pertaining to confidence indicator(s) for one or more confidence levels may be presented via a pop-up window or other user interface object.

In some implementations, the visual representation is configured to provide information pertaining to a confidence level responsive to user interaction with a portion of the visual representation. More particularly, the visual representation may be configured to provide an indication of the likelihood of achieving a particular improvement percentage or particular goal amount by a point in time corresponding to the portion of the visual representation with which the user has interacted. For example, the user may select a portion within the visual representation, where the portion corresponds to a particular point in time, November 2018. In addition, the visual representation may indicate that the predicted goal amount in November 2018 is 50,000. In response, the system may provide an indication of the likelihood of achieving the predicted goal amount of 50,000 by November 2018. Such an indication may be provided via a pop-up window or other form of user interface object.

In some implementations, the simulation is generated responsive to processing an indication of user input indicating a request to generate the simulation. For example, the user may click “Run Simulation” to initiate the generation of a simulation. After the simulation is generated and a visual representation of the simulation is provided for display, the user may choose to save the simulation for future reference.

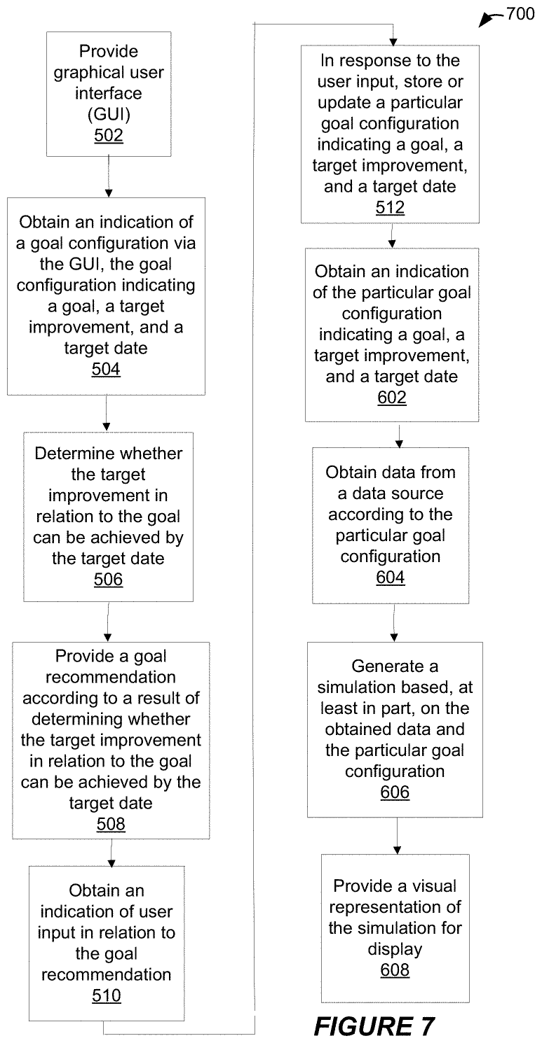

FIG. 7 shows an example of a method 700 for simulating goal progression of a recommended goal, in accordance with some implementations. As described above with reference to FIG. 5, a goal recommendation may be provided based upon an indication of a goal configuration obtained via a GUI. An indication of user input in relation to the goal recommendation may be obtained at 510. In response to the user input, the system may store or update a particular goal configuration at 512, where the particular goal configuration indicates a goal (e.g., identifier), a target improvement, and a target date. The system may then proceed to generate a simulation for the particular goal configuration, as described above with reference to FIG. 6.

Access to goals, goal tracking information, or goal simulations may be limited to authorized individuals. An identity of authorized individuals may be indicated by the user during the goal configuration process and stored in association with the goal.

Some but not all of the techniques described or referenced herein are implemented using or in conjunction with a social networking system. Social networking systems have become a popular way to facilitate communication among people, any of whom can be recognized as users of a social networking system. One example of a social networking system is Chatter®, provided by salesforce.com, inc. of San Francisco, Calif. salesforce.com, inc. is a provider of social networking services, CRM services and other database management services, any of which can be accessed and used in conjunction with the techniques disclosed herein in some implementations. In some but not all implementations, these various services can be provided in a cloud computing environment, for example, in the context of a multi-tenant database system. Thus, the disclosed techniques can be implemented without having to install software locally, that is, on computing devices of users interacting with services available through the cloud. The term “multi-tenant database system” generally refers to those systems in which various elements of hardware and/or software of a database system may be shared by one or more customers. For example, a given application server may simultaneously process requests for a great number of customers, and a given database table may store rows of data such as feed items for a potentially much greater number of customers.

In accordance with various implementations, a “user profile” or “user's profile” is a database object or set of objects configured to store and maintain data about a given user of a social networking system and/or database system. The data can include general information, such as name, title, phone number, a photo, a biographical summary, and a status, e.g., text describing what the user is currently doing. As mentioned below, the data can include social media messages created by other users. Where there are multiple tenants, a user is typically associated with a particular tenant. For example, a user could be a salesperson of a company, which is a tenant of the database system that provides a database service.

The term “record” generally refers to a data entity having fields with values and stored in database system. An example of a record is an instance of a data object created by a user of the database service, for example, in the form of a CRM record about a particular (actual or potential) business relationship or project. The record can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

A record can have a status, the update of which can be provided by an owner of the record or other users having suitable write access permissions to the record. The owner can be a single user, multiple users, or a group.

Updates to a record, also referred to herein as changes to the record, are one type of information update that can occur. Examples of record updates include field changes in the record, updates to the status of a record, as well as the creation of the record itself. Some records are publicly accessible, such that any user can follow the record, while other records are private, for which appropriate security clearance/permissions are a prerequisite to a user obtaining access to the record.

Information updates can include various types of updates, which may or may not be linked with a particular record. For example, information updates can be social media messages submitted by a user or can be otherwise generated in response to user actions or in response to events.

A “group” is generally a collection of users. In some implementations, the group may be defined as users with a same or similar attribute, or by membership.

Some non-limiting examples of systems, apparatus, and methods are described below for implementing database systems and enterprise level social networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed.

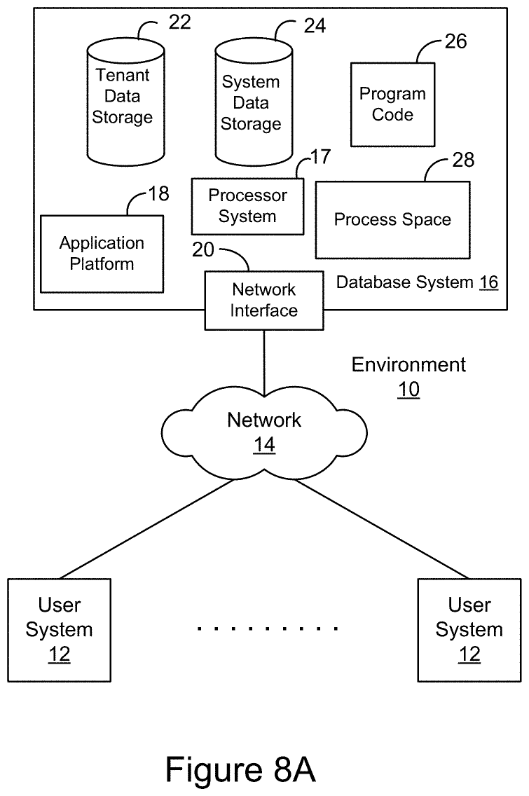

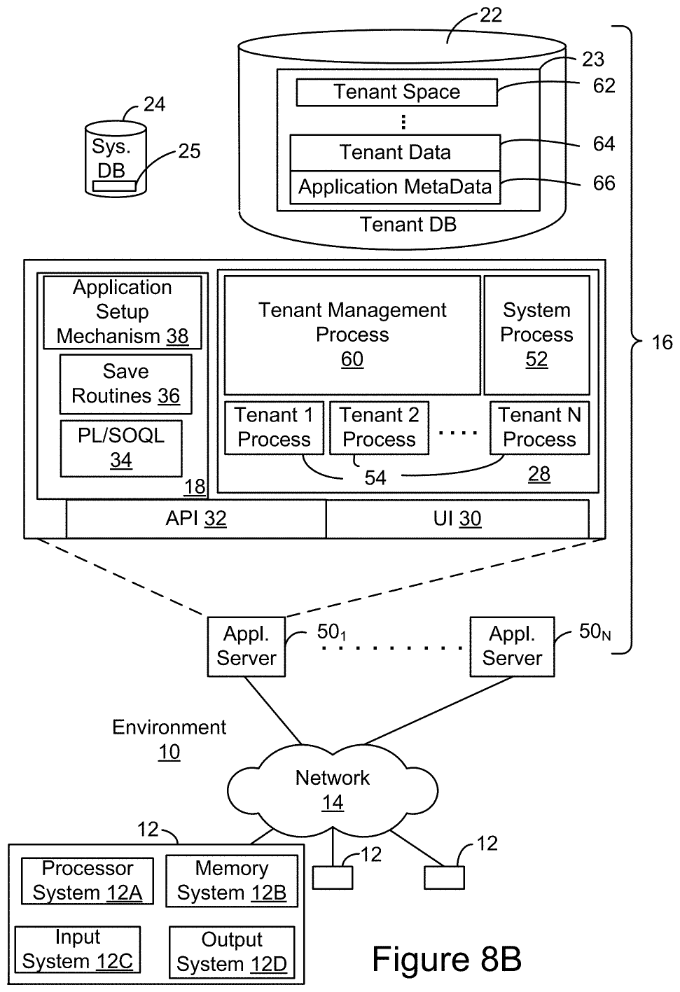

FIG. 8A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 8A (and in more detail in FIG. 8B) user systems 12 might interact via a network 14 with an on-demand database service, which is implemented in the example of FIG. 8A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 8A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIGS. 7A and 7B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 8A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 8B shows a block diagram of an example of some implementations of elements of FIG. 8A and various possible interconnections between these elements. That is, FIG. 8B also illustrates environment 10. However, in FIG. 8B elements of system 16 and various interconnections in some implementations are further illustrated. FIG. 8B shows that user system 12 may include processor system 12A, memory system 12B, input system 12C, and output system 12D. FIG. 8B shows network 14 and system 16. FIG. 8B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 8A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 8B, system 16 may include a network interface 20 (of FIG. 8A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example. Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

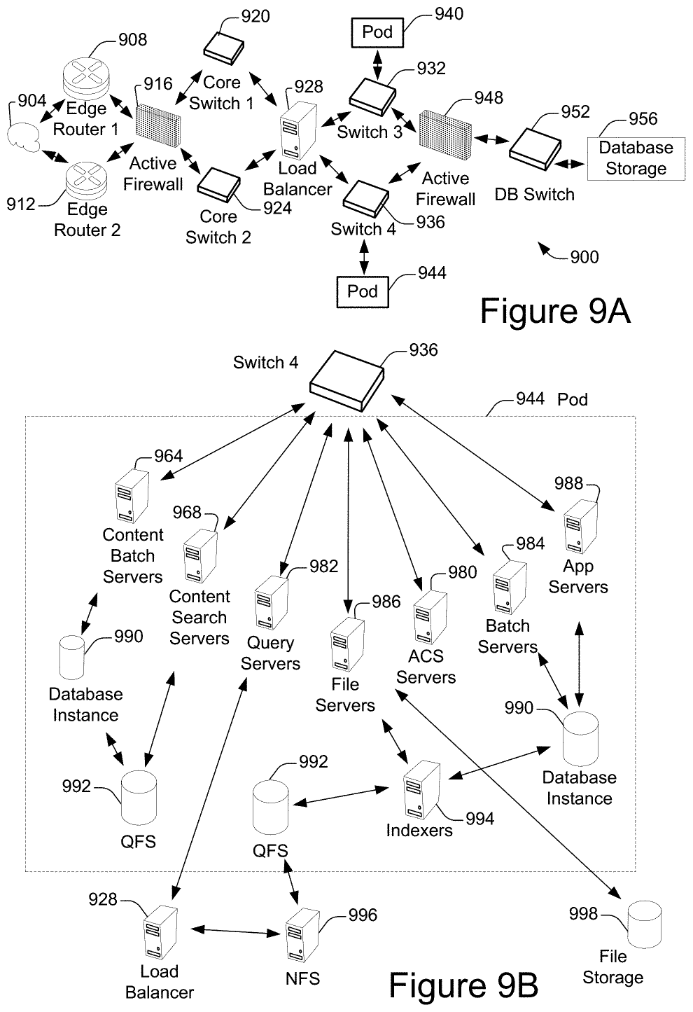

FIG. 9A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 8A and 8B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 8A and 8B, some implementations of an on-demand database service environment may include anywhere from one to many devices of each type. Also, the on-demand database service environment need not include each device shown in FIGS. 8A and 8B, or may include additional devices not shown in FIGS. 8A and 8B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 9B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 9A and 9B.

FIG. 9B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

In some implementations, one or more application servers or other servers described above with reference to FIGS. 7A and 7B include a hardware and/or software framework configurable to execute procedures using programs, routines, scripts, etc. Thus, in some implementations, one or more of application servers 50₁-50_{N} of FIG. 8B can be configured to initiate performance of one or more of the operations described above by instructing another computing device to perform an operation. In some implementations, one or more application servers 50₁-50_{N} carry out, either partially or entirely, one or more of the disclosed operations. In some implementations, app servers 988 of FIG. 9B support the construction of applications provided by the on-demand database service environment 900 via the pod 944. Thus, an app server 988 may include a hardware and/or software framework configurable to execute procedures to partially or entirely carry out or instruct another computing device to carry out one or more operations disclosed herein. In alternative implementations, two or more app servers 988 may cooperate to perform or cause performance of such operations. Any of the databases and other storage facilities described above with reference to FIGS. 7A, 7B, 8A and 8B can be configured to store lists, articles, documents, records, files, and other objects for implementing the operations described above. For instance, lists of available communication channels associated with share actions for sharing a type of data item can be maintained in tenant data storage 22 and/or system data storage 24 of FIGS. 7A and 7B. By the same token, lists of default or designated channels for particular share actions can be maintained in storage 22 and/or storage 24. In some other implementations, rather than storing one or more lists, articles, documents, records, and/or files, the databases and other storage facilities described above can store pointers to the lists, articles, documents, records, and/or files, which may instead be stored in other repositories external to the systems and environments described above with reference to FIGS. 7A, 7B, 8A and 8B.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (ROM) devices and random access memory (RAM) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A system comprising:
a database system implemented using a server system, the database system configurable to cause:
providing a graphical user interface (GUI) including at least one user interface object for display by a client device, the user interface object including one or more user interface elements configured to obtain user input in relation to configuration of a goal;
obtaining, via the GUI, an indication of a goal configuration, the goal configuration indicating a goal defined by a goal definition, a target improvement in relation to the goal, and a target date, the target improvement including a numerical value indicating a target percentage increase or decrease in relation to the goal by the target date, the goal definition including a formula identifying two or more database fields corresponding to database records of at least one data source;
responsive to obtaining the indication of the goal configuration, determining whether the target improvement in relation to the goal can be achieved by the target date; and
providing a goal recommendation for display by the client device according to a result of determining whether the target improvement in relation to the goal can be achieved by the target date, the goal recommendation including at least one of: a) a recommended target improvement including a second numerical value indicating a recommended target percentage increase or decrease in relation to the goal, b) a recommended modification to the goal definition, or c) a recommended modification to the target date.

2. The system of claim 1, the database system further configurable to cause:
obtaining an indication of user input in relation to the goal recommendation; and
responsive to processing the indication of user input in relation to the goal recommendation, storing or updating a particular goal configuration associated with the goal, the particular goal configuration indicating a particular numerical value representing a particular target improvement in relation to the goal and indicating a particular target date.

3. The system of claim 1, the database system further configurable to cause:
obtaining data from the data source according to the particular goal definition; and
generating simulation data based, at least in part, on the obtained data and the goal configuration, the simulation data representing predicted future performance in relation to the goal over a period of time;
wherein determining whether the target improvement in relation to the goal can be achieved by the target date is performed based, at least in part, on the simulation data.

4. The system of claim 3, wherein generating the simulation is performed further based, at least in part, on one or more of: a) one or more additional goal configurations, each of the additional goal configurations indicating a corresponding goal defined by a corresponding goal definition, a corresponding target improvement in relation to the goal, and a corresponding target date, the target improvement of each of the additional goal configurations including a numerical value indicating a corresponding target percentage increase or decrease in relation to the corresponding goal by the corresponding target date, each goal definition being defined by a corresponding formula identifying two or more database fields corresponding to database records of at least one data source, b) one or more scheduled product releases, or c) one or more scheduled advertising campaigns.

5. The system of claim 1, the database system further configurable to cause:
obtaining data from the data source according to the particular goal definition;
extrapolating the obtained data over time according to the target date such that extrapolated data is generated;
wherein determining whether the target improvement in relation to the goal can be achieved by the target date is performed based, at least in part, on the extrapolated data.

6. The system of claim 1, the database system further configurable to cause:
tracking progression toward the particular target improvement in relation to the goal based, at least in part, on data obtained from the data source according to the goal definition.

7. The system of claim 1, the goal recommendation further indicating a level of confidence associated with the goal recommendation, the level of confidence indicating a likelihood that an improvement according to the goal recommendation can be achieved.

8. A method, comprising:
providing a graphical user interface (GUI) including at least one user interface object for display by a client device, the user interface object including one or more user interface elements configured to obtain user input in relation to configuration of a goal;
obtaining, via the GUI, an indication of a goal configuration, the goal configuration indicating a goal defined by a goal definition, a target improvement in relation to the goal, and a target date, the target improvement including a numerical value indicating a target percentage increase or decrease in relation to the goal by the target date, the goal definition including a formula identifying two or more database fields corresponding to database records of at least one data source;
responsive to obtaining the indication of the goal configuration, determining whether the target improvement in relation to the goal can be achieved by the target date; and
providing a goal recommendation for display by the client device according to a result of determining whether the target improvement in relation to the goal can be achieved by the target date, the goal recommendation including at least one of: a) a recommended target improvement including a second numerical value indicating a recommended target percentage increase or decrease in relation to the goal, b) a recommended modification to the goal definition, or c) a recommended modification to the target date.

9. The method of claim 8, further comprising:
obtaining an indication of user input in relation to the goal recommendation; and
responsive to processing the indication of user input in relation to the goal recommendation, storing or updating a particular goal configuration associated with the goal, the particular goal configuration indicating a particular numerical value representing a particular target improvement in relation to the goal and indicating a particular target date.

10. The method of claim 8, further comprising:
obtaining data from the data source according to the particular goal definition; and
generating simulation data based, at least in part, on the obtained data and the goal configuration, the simulation data representing predicted future performance in relation to the goal over a period of time;
wherein determining whether the target improvement in relation to the goal can be achieved by the target date is performed based, at least in part, on the simulation data.

11. The method of claim 10, wherein generating the simulation is performed further based, at least in part, on one or more of: a) one or more additional goal configurations, each of the additional goal configurations indicating a corresponding goal defined by a corresponding goal definition, a corresponding target improvement in relation to the goal, and a corresponding target date, the target improvement of each of the additional goal configurations including a numerical value indicating a corresponding target percentage increase or decrease in relation to the corresponding goal by the corresponding target date, each goal definition being defined by a corresponding formula identifying two or more database fields corresponding to database records of at least one data source, b) one or more scheduled product releases, or c) one or more scheduled advertising campaigns.

12. The method of claim 8, further comprising:
obtaining data from the data source according to the particular goal definition;
extrapolating the obtained data over time according to the target date such that extrapolated data is generated;
wherein determining whether the target improvement in relation to the goal can be achieved by the target date is performed based, at least in part, on the extrapolated data.

13. The method of claim 8, further comprising:
tracking progression toward the particular target improvement in relation to the goal based, at least in part, on data obtained from the data source according to the goal definition.

14. The method of claim 8, the goal recommendation further indicating a level of confidence associated with the goal recommendation, the level of confidence indicating a likelihood that an improvement according to the goal recommendation can be achieved.

15. A computer program product comprising computer-readable program code capable of being executed by one or more processors when retrieved from a non-transitory computer-readable medium, the program code comprising instructions configurable to cause:
providing a graphical user interface (GUI) including at least one user interface object for display by a client device, the user interface object including one or more user interface elements configured to obtain user input in relation to configuration of a goal;
obtaining, via the GUI, an indication of a goal configuration, the goal configuration indicating a goal defined by a goal definition, a target improvement in relation to the goal, and a target date, the target improvement including a numerical value indicating a target percentage increase or decrease in relation to the goal by the target date, the goal definition including a formula identifying two or more database fields corresponding to database records of at least one data source;
responsive to obtaining the indication of the goal configuration, determining whether the target improvement in relation to the goal can be achieved by the target date; and
providing a goal recommendation for display by the client device according to a result of determining whether the target improvement in relation to the goal can be achieved by the target date, the goal recommendation including at least one of: a) a recommended target improvement including a second numerical value indicating a recommended target percentage increase or decrease in relation to the goal, b) a recommended modification to the goal definition, or c) a recommended modification to the target date.

16. The computer program product of claim 15, the program code comprising instructions further configurable to cause:
obtaining an indication of user input in relation to the goal recommendation; and
responsive to processing the indication of user input in relation to the goal recommendation, storing or updating a particular goal configuration associated with the goal, the particular goal configuration indicating a particular numerical value representing a particular target improvement in relation to the goal and indicating a particular target date.

17. The computer program product of claim 15, the program code comprising instructions further configurable to cause:
obtaining data from the data source according to the particular goal definition; and
generating simulation data based, at least in part, on the obtained data and the goal configuration, the simulation data representing predicted future performance in relation to the goal over a period of time;
wherein determining whether the target improvement in relation to the goal can be achieved by the target date is performed based, at least in part, on the simulation data.

18. The computer program product of claim 17, wherein generating the simulation is performed further based, at least in part, on one or more of: a) one or more additional goal configurations, each of the additional goal configurations indicating a corresponding goal defined by a corresponding goal definition, a corresponding target improvement in relation to the goal, and a corresponding target date, the target improvement of each of the additional goal configurations including a numerical value indicating a corresponding target percentage increase or decrease in relation to the corresponding goal by the corresponding target date, each goal definition being defined by a corresponding formula identifying two or more database fields corresponding to database records of at least one data source, b) one or more scheduled product releases, or c) one or more scheduled advertising campaigns.

19. The computer program product of claim 15, the program code comprising instructions further configurable to cause:
obtaining data from the data source according to the particular goal definition;
extrapolating the obtained data over time according to the target date such that extrapolated data is generated;
wherein determining whether the target improvement in relation to the goal can be achieved by the target date is performed based, at least in part, on the extrapolated data.

20. The computer program product of claim 15, the goal recommendation further indicating a level of confidence associated with the goal recommendation, the level of confidence indicating a likelihood that an improvement according to the goal recommendation can be achieved.
